(19) United States
(12) Patent Application Publication
(10) Pub. No.: US 2011/0315168 A1
(43) Pub. Date: Dec. 29, 2011

(54) Acid Compositions for Removing Oxalates

(76) Inventors: Jean-Alex Laffitte, Pau (FR); Vijay R. Srinivas, Exton, PA (US)

(21) Appl. No.: 13/170,688

(22) Filed: Jun. 28, 2011

Related U.S. Application Data
(60) Provisional application No. 61/359,483, filed on Jun. 29, 2010.

(30) Foreign Application Priority Data
Jun. 29, 2010 (FR) 10.55183

(51) Int. Cl. B08B 3/00; C11D 3/60; C11D 7/60

(52) U.S. Cl. 134/26; 510/109; 510/218; 510/191

(57) ABSTRACT

The present invention relates to the field of cleaning in general, and in particular that of industrial cleaning and of domestic cleaning. More specifically, the invention aims to remove scale, oxalate scale, comprising salts of oxalic acid, and mainly mineral salts of oxalic acid, by means of a mixture of acids comprising at least one alkanesulphonic acid and at least one other mineral acid.

The present invention relates to the field of cleaning in general, and in particular to that of industrial cleaning and of domestic cleaning. More specifically, the invention targets the removal of scale, mainly oxalate scale, that is to say the removal of residues comprising salts of oxalic acid, and mainly mineral salts of oxalic acid, such as alkali metal and alkaline-earth metal oxalates, typically oxalates of calcium, sodium, potassium, etc.

The salts of oxalic acid, in particular the alkaline-earth metal salts and especially calcium oxalate, are known to be solids that are not very soluble in water, and in most of the known detergent compositions. It is necessary to use acids, usually strong mineral acids at relatively high concentrations, in order to succeed in solubilising and thus removing these salts which are especially responsible for the formation of scale in very many fields.

However, the acids used today prove to be not very effective, or not sufficiently effective, or else not very environmentally friendly. Thus, hydrochloric acid, which has an effectiveness that is however satisfactory, often leads to premature oxidation of stainless steels, and especially pitting corrosion, which can not be accepted in the agri-food industry.

Sulphamic acid and phosphoric acid, which do not contain chloride ions, are approved for the treatment of installations in contact with foodstuffs. Sulphuric acid is avoided because it leads to the formation of calcium sulphate which is not very soluble.

Methanesulphonic acid (also denoted by the abbreviation MSA) is recommended for the removal of carbonate and oxalate scale, and its descaling power is generally greater than that of the acids commonly used in these applications.

Oxalates are present in a very large number of fields, in particular in all the fields where living microorganisms are present, and especially in the agri-food industry, in the preparation, storage and transport of products that carry out, or are capable of undergoing, a fermentation or degradations due to the fermentation of said microorganisms.

Thus, the oxalate scale is present in the soiling customarily encountered in the dairy and cheese industries, in industries where fermented beverages are prepared, especially the brewing industries, in the fields of the storage, transport and processing of early horticultural produce, vegetables, fruits, meat, fish, etc.

Oxalates are also responsible for scale formation in the industries for the preparation of papermaking pulp, for the manufacture of sugar from sugar beet, for the storage, processing and treatment of cocoa beans, tea, etc.

Oxalate scale is also the cause of the soiling present in domestic and communal sanitary installations (kitchens, bathrooms, showers and toilets).

Oxalates thus lead, via accumulation, to the formation of solid residues that are difficult to remove, causing a scale formation phenomenon, which may in particular partly or completely block the pipes, and/or form a protective layer for the development of bacteria which will consequently not be able to be removed, even during washing with disinfectants or biocides.

This scale formation phenomenon thus represents real problems in terms of production yields, hygiene and health.

It is therefore important and necessary to have compositions for cleaning oxalate scale that are evermore effective, more environmentally friendly, and of rapid action, requiring smaller volumes of cleaning compositions.

The inventors have now discovered that the effectiveness of mineral or organic acids, in particular of mineral acids, with respect to removing oxalate scale, can be greatly increased when they are used in combination with at least one alkanesulphonic acid, which makes it possible to achieve, fully or in part, the aforementioned objectives.

Thus, it has been found that the combination of at least one alkanesulphonic acid with at least one mineral acid results in a much greater dissolution efficiency of organic or mineral oxalates, and in particular of mineral oxalates, such as calcium oxalate, than when said mineral acids are used alone.

Therefore, the main subject of the invention is a composition for descaling oxalates comprising, or consisting of, a mixture of at least one alkanesulphonic acid with at least one other mineral acid.

The expression “mineral acid” is understood to mean all known mineral acids and in particular those commonly used by a person skilled in the art for removing/dissolving oxalates, more particularly mineral acids chosen from hydrochloric acid, sulphuric acid, sulphamic acid, phosphoric acid, nitric acid, etc. and also mixtures of two or more of them in any proportions. The mineral acids preferred within the context of the present invention are phosphoric and nitric acids, and also mixtures thereof.

In the present invention, the expression “alkanesulphonic acid” is understood to preferably mean the alkanesulphonic acids of formula R—SO₃H, where R represents a linear or branched saturated hydrocarbon-based chain comprising from 1 to 4 carbon atoms.

The alkanesulphonic acids that can be used within the context of the present invention are particularly chosen from methanesulphonic acid, ethanesulphonic acid, n-propanesulphonic acid, iso-propanesulphonic acid, n-butanesulphonic acid, iso-butanesulphonic acid, sec-butanesulphonic acid, tert-butanesulphonic acid, and mixtures of two or more of them in any proportions.

According to one preferred embodiment, the alkanesulphonic acid used within the context of the present invention is methanesulphonic acid or ethanesulphonic acid, very preferably the acid used is methanesulphonic acid.

Thus, the present invention uses at least one alkanesulphonic acid chosen from the alkanesulphonic acids having a linear or branched chain comprising from 1 to 4 carbon atoms, and preferably at least methanesulphonic acid (MSA), as sold by Arkema under the name Scaleva®, or else by BASF under the name Lutropur®.

The expression “oxalate scale” is understood, within the meaning of the present invention, to mean any type of mineral or organic, solid or pasty residue comprising at least one organic or mineral salt of oxalic acid, and in particular at least one alkaline-earth metal salt of oxalic acid, more particularly at least one calcium oxalate.

Within the present invention, the expressions “descaling of oxalates”, “cleaning of oxalate scale” and “dissolution of oxalate soiling” mean the cleaning or pickling of all types of surfaces soiled, coated or covered, completely or partly, by residues, scales or depositions that are dry or still wet, comprising at least one oxalic acid salt defined previously, by removing or dissolving said residues, scales or depositions.

These expressions also encompass the partial or complete removal of solid or pasty residues comprising at least one oxalic acid salt, as defined above, which are responsible for unplanned or undesirable soiling, depositions and clogging, and which are customarily stripped/removed by chemical and/or physical means.

It has been discovered, quite surprisingly, that the combination of at least one alkanesulphonic acid with at least one mineral acid results in a descaling acid composition that is much more effective than the acid composition that does not contain alkanesulphonic acid.

According to a first preferred embodiment, the present invention relates to a solution for descaling oxalates that comprises phosphoric acid (H₃PO₄) and an alkanesulphonic acid, preferably methanesulphonic acid (MSA).

It has been observed that an equivalent amount of this H₃PO₄/MSA combination relative to the same amount of H₃PO₄ makes it possible to dissolve a larger amount of oxalate scale, in particular of calcium oxalate.

Moreover, when the combination comprises between 40% and 85% of MSA and between 60% and 15% of H₃PO₄, for example around 75% of MSA and around 25% of H₃PO₄, or else around 50% of MSA and around 50% of H₃PO₄, a synergy has been observed, that is to say that said H₃PO₄/MSA combination enables a more effective dissolution than that which is expected theoretically by calculation for dissolving calcium oxalate.

The percentages (%) indicated in the description of the present invention are expressed by weight, unless expressly indicated otherwise. The methanesulphonic acid used in the present invention is 70% methanesulphonic acid in water. The phosphoric acid is 85% phosphoric acid in water and the nitric acid is 68% nitric acid in water.

According to a second preferred embodiment, the present invention relates to a solution for descaling oxalates comprising nitric acid (HNO₃) and an alkanesulphonic acid, preferably methanesulphonic acid.

It has furthermore been observed that when the combination comprises between 5% and 30% of MSA and between 95% and 70% of HNO₃, preferably around 10% of MSA and around 90% of HNO₃, a synergy was observed, that is to say that said HNO₃/MSA combination enables a dissolution that is more effective than HNO₃ used alone, but also more effective than MSA used alone, for dissolving calcium oxalate.

The compositions according to the invention are thus very particularly well suited for cleaning and dissolving oxalate scale. By virtue of their acid nature, these combinations are also suitable for removing all other types of soiling also present with the oxalates, whether this is organic or mineral soiling, such as calcium carbonate.

The compositions for descaling oxalates according to the invention may be used pure or diluted in any aqueous, organic or aqueous-organic medium. However, aqueous formulations are preferred, that is to say formulations that are diluted in water, for example at total acid concentrations between 0.2% and 50% relative to the total weight of the formulation, preferably between 0.5% and 20%, more preferably between around 0.5% and 10% relative to the total weight of the formulation.

The concentration of acids in the formulation depends on many factors, among which mention may be made of the amount and the nature of the oxalates to be cleaned, the nature and the shape of the surface to be cleaned, the temperature at which the formulation is applied, etc. A person skilled in the art will be able to adapt the concentration of acids in the formulation without excessive effort.

The acid compositions according to the invention may be formulated in the form of concentrated mixtures, concentrates that can be diluted by the end user. As a variant, the formulations may also be ready-to-use formulations, that is to say that they do not need to be diluted. Finally, within the meaning of the present invention, the acid compositions may be constituted exclusively of at least one alkanesulphonic acid and of at least one mineral acid, optionally and preferably in solution in water, at various concentrations.

Moreover, the acid descaling compositions according to the invention may be formulated by optional addition of one or more additives, such as for example those chosen from:
solvents, hydrotropic agents or solubilisers (for example alcohols, esters, ketones, amides, etc.);
biocides, disinfectants (bromoacetic acid, peracetic acid, salicylic acid, aqueous hydrogen peroxide solution, etc.);
rheological agents or texturing agents or thickeners or gelling agents (sugars, polysaccharides, alginates, silica, amorphous silica, gums, etc.);
flame retardants;
preservatives;
anionic, cationic, nonionic or amphoteric surfactants (such as ethoxylated alcohols and/or amines, alkylsulphonates and/or arylsulphonates), emulsifiers, detergents, soaps, etc.;
organic or mineral acids (for example sulphuric acid, phosphoric acid, nitric acid, sulphamic acid, acetic acid, citric acid, formic acid, lactic acid, glycolic acid, oxalic acid, etc.);
foaming agents and antifoaming agents;
antifreezes (for example ethylene glycol, propylene glycol, etc.);
colorants;
fragrances, odorous agents;
corrosion-inhibiting additives;
and other additives known to a person skilled in the art.

According to one variant, the acid compositions of the present invention are formulated in the form of a gel. This is because it has been observed that formulations in the form of gels can prove very effective for removing soiling based on oxalate scale, not only due to the gel itself which allows a longer action of the acid active principle (the gel “adheres” to surfaces for a longer time, relative to an aqueous formulation), but also due to the improved cleaning power, relative to other gel formulations.

The gelling agents and the surfactants that can be used in the formulations in the form of gel may be of any type known to a person skilled in the art who will be able, with no particular difficulty and by being inspired by the examples that follow, to choose and adapt the nature of the appropriate gelling agents and surfactants.

According to another aspect, the present invention relates to a formulation in the form of a foaming gel. This is because foaming gels are very particularly advantageous since they produce a tacky foam, in other words a foam that adheres to the soiled surfaces, while requiring a lower consumption of cleaning acid active material, and having the advantage of a better rinsability, that is to say a simpler and more effective removal, while requiring a smaller amount of water.

Depending on the field and the mode of application, foaming gels may be formulated in a concentrated form, and with a suitable low viscosity, then diluted before use until the expected efficacy, as regards the viscosity and the foaming power, is obtained.

In the foaming gel formulations described above, the foaming agent may be chosen from the foaming agents commonly used by a person skilled in the art, and preferably from amine oxides, such as, for example:
dimethylalkylamine oxides, the alkyl chain being a “fatty” chain, containing for example from 10 to 30 carbon atoms, preferably from 12 to 22 carbon atoms;
ethoxylated amine oxides; and
mixtures of two or more of them.

The use of at least one ethoxylated amine oxide, such as, nonlimitingly, Cecajel® OX100 from CECA, or Aromox® T12 from Akzo, alone or in combination with at least one dimethylalkylamine oxide makes it possible, for example, to provide stability to the foaming gel.

The foaming agents, and in particular those described above, generally form gels when they are mixed with water, that is to say when they increase the viscosity of the formulation, without it being necessary to add a gelling agent. However, the addition of such a gelling agent is not excluded from the present invention.

Among the solubilising or hydrotropic agents that can be used within the context of the present invention, mention may be made, by way of example and non-limitingly, of sodium xylenesulphonate or sodium cumenesulphonate. Such agents are not however essential in the acid compositions according to the invention.

The acid compositions according to the present invention, whether they are in the form of concentrated or dilute liquids, gels or foaming gels, may be applied according to any method known to a person skilled in the art, and in particular under pressure, or else using a spray gun.

According to another aspect, the present invention relates to the use of a composition of acids as defined previously for descaling, cleaning or dissolving any type of scale comprising at least one mineral or organic salt of oxalic acid, and in particular at least one alkaline-earth metal salt, more particularly at least one calcium oxalate.

According to yet another aspect, the present invention relates to a process for descaling, cleaning or dissolving any type of scale comprising at least one mineral or organic salt of oxalic acid defined above present, for example, in the form of residues, scales or depositions that are dry or still wet, comprising at least one step of bringing an effective amount of at least one composition of acids according to the invention, in the form of an aqueous, organic or aqueous-organic formulation, in the form of a solution, gel or foaming gel, such as have just been described, into contact with said mineral or organic salt of oxalic acid to be removed, by contact, immersion, sprinkling, spraying, applying a thick or thin layer, optionally using appropriate tools known to a person skilled in the art (paint brushes, brushes, spatulas, etc.), said contacting step being optionally followed by one or more steps of rinsing and/or drying.

The contacting time may vary to a wide extent, depending on the concentration and on the quantity of acids used, on the nature of the oxalate scale to be dissolved, on the nature of the surface to be cleaned, etc. This contacting step may be followed by a reaction time necessary for the dissolution of the oxalate scale that it is desired to remove, this reaction time possibly varying from a few seconds to a few hours, or even a few days, depending on the temperature at which the cleaning is carried out, the application pressure of the acids, the amount of scale to be removed, its degree of encrustation, and also the nature of the surfaces to be treated.

However, it has been observed that the combinations of the aforementioned acids which form one of the subjects of the present invention make it possible to significantly reduce the duration of action with respect to a similar process using a single acid, without alkanesulphonic acid.

The temperature at which the process described above is carried out may vary to a wide extent and is generally between −20° C. and 150° C., preferably between 0° C. and 80° C., more preferably between 10° C. and 80° C. According to one preferred embodiment, the usage temperature is ambient temperature or else a temperature between ambient temperature and around 80° C.

It may thus be envisaged to bring the composition of acids and the surface to be treated to temperature, this temperature possibly being identical or different, or else to bring either the composition of acids or the surface to be treated to temperature.

Finally, after the step of treatment(s), and of optional rinsing(s), the cleaned surface may be, where appropriate and if necessary, dried, according to any method known to a person skilled in the art, for example with air, under a stream of more or less hot air, in an oven, by heating (electrical heating, heating lamps), wiping (absorbent textiles or papers), etc.

This operation of removing oxalate scale may be repeated one or more times depending on the amount of scale to be removed, and its degree of encrustation on the surfaces to be treated.

The treatment by the composition of acids as has just been defined may optionally be accompanied and/or followed by one or more mechanical operations (agitation, scraping, brushing, etc.), in order to improve the acid chemical action, if necessary.

Finally, the treatment may optionally be followed by one or more rinsing operations, for example with clean water, solvent(s) or water/solvent(s) mixture(s).

It should also be noted that the compositions according to the invention, and especially the synergistic compositions comprising nitric acid that are more effective than nitric acid used alone, make it possible to reduce the effective amounts of nitric acid and consequently the appearance of corrosion phenomena, especially during the cleaning of metallic surfaces, which corrosion is frequently observed on said metallic surfaces during the use of nitric acid alone.

Thus, the compositions of acids according to the present invention find quite advantageous uses in all the industrial, domestic or communal fields of use faced with the problems of the appearance of oxalate scale, resulting from the formation of insoluble salts of oxalic acid and especially the alkaline-earth metal salts, and in particular calcium oxalate.

Consequently, the compositions of acids according to the present invention may advantageously replace the mineral acids commonly used for descaling oxalate scale which may, for example, be found in the dairy and cheese industries, in industries where fermented beverages are prepared, especially brewing industries, in the fields of storage, transport and processing of early horticultural produce, vegetables (spinach for example), fruit (cocoa bean, tea, sugar beet, etc.), meat, fish, etc., but also for cleaning sanitary installations (sinks, basins, baths, showers, toilets) and also in the paper industry, and, as a general rule, any type of industry faced with the problem of the accumulation of oxalate scale.

Due to their great effectiveness, the compositions of acids of the present invention also prove effective for cleaning any type of soiling, such as rust, carbonate scale, but also all types of organic soiling (animal faeces and droppings), etc.

The present invention is now illustrated by means of the examples which follow, without exhibiting any limiting nature, and which cannot consequently be understood as capable of restricting the scope of the invention as claimed.

### EXAMPLE 1 (COMPARATIVE)

### Test for the Dissolution of Calcium Carbonate with MSA/H₃PO₄

The dissolution tests are carried out on 3 g of calcium carbonate (cube of marble) immersed in 50 g of a composition of acids according to the invention at a concentration of 1% in water.

The acids used are methanesulphonic acid (MSA) at a concentration of 70% in water from Sobegi, sold under the name Scaleva®, and phosphoric acid at a concentration of 85% in water, Normapur from VWR. 3 mixtures of different ratios are prepared: H₃PO₄/MSA respectively of 1/3, 1/1, and 3/1 by weight. These mixtures are then diluted to 1% of total acids in water.

Introduced into a 250 ml single-necked flask are 50 g of a solution of acids in water having a concentration of 1% of active material (acids), then 3 g of a cube of marble (calcium carbonate). The flask is sealed using a stopper.

The flask is placed in a bath thermostatically controlled at 70° C. and subjected to lateral agitation (speed 100 in Politest® 20 machine from Bioblock Scientific) for 5 minutes or 15 minutes.

The cube of marble is then withdrawn from the flask, dried with absorbent paper, then immersed in 3 successive baths each of 50 ml of ultrapure water. The cube is again dried on absorbent paper, and placed in an oven at 40° C. for 20 minutes. The cube is then weighed at ambient temperature in order to determine the mass of calcium carbonate dissolved.

The results are presented in Table 1 below:

TABLE 1

| | | Mass of Ca²⁺ | Mass of Ca²⁺ |
|---|---|---|---|
| | Concentration of | dissolved in 5 | dissolved in 15 |
| Formulation of acids | acids in water (%) | minutes (mg/L) | minutes (mg/L) |
| H₃PO₄ | 1.01 | 706 | 1457 |
| MSA | 1.00 | 1172 | 1961 |
| H₃PO₄/MSA 1/1 by | 1.01 | 936 | 1666 |
| weight | | | |
| H₃PO₄/MSA 1/3 by | 1.02 | 1082 | 1834 |
| weight | | | |
| H₃PO₄/MSA 3/1 by | 1.02 | 744 | 1513 |
| weight | | | |

It is observed that MSA is still more active than phosphoric acid for dissolving calcium carbonate. MSA is around 1.3 times more active than phosphoric acid after 15 minutes and around 1.7 times more active than phosphoric acid after 5 minutes.

Moreover, the activity of the acids is not proportional to the time, the efficacy is not three times greater after 15 minutes than after 5 minutes.

It is therefore concluded that the use of a mixture of MSA and of phosphoric acid does not result in a significant improvement of the dissolution of calcium carbonate.

### EXAMPLE 2 (ACCORDING TO THE INVENTION)

### Dissolution of Calcium Oxalate with an MSA/H₃PO₄ Mixture

The dissolution tests from Example 1 are carried out again by replacing 3 g of calcium carbonate with 3 g of calcium oxalate immersed in 50 g of a composition of acids according to the invention at a concentration of 1% in water.

The solubilisation is measured by inductively coupled plasma (ICP) and the results are given by the concentration of Ca²⁺ ions in mg/L.

Introduced into a 250 ml single-necked flask are 50 g of a solution of acids in water having a concentration of 1% of active material (acids), then 3 g of calcium oxalate. The flask is sealed using a stopper.

The flask is placed in a bath thermostatically controlled at 70° C. and subjected to lateral agitation (speed 100 in Politest® 20 machine from Bioblock Scientific) for 5 minutes or 15 minutes.

The solution is then filtered over a 0.22 μm Acridisc®, then the sample is analysed by ICP.

The results are presented in Table 2 below:

TABLE 2

| | | | Demineralised | | | | |
|---|---|---|---|---|---|---|---|
| | H₃PO₄ | MSA | water | % of | H₃PO₄ | MSA | Ca²⁺ |
| | (g) | (g) | (qs in g) | acids | (%) | (%) | (mg/L) |
| After 5 | 2.4 | 0.0 | 200.0 | 1.01 | 1.01 | 0.00 | 110 |
| minutes | 0.0 | 2.9 | 203.2 | 1.00 | 0.00 | 1.00 | 250 |
| | 1.2 | 1.4 | 200.0 | 1.01 | 0.51 | 0.50 | 230 |
| | 0.6 | 2.2 | 200.0 | 1.02 | 0.26 | 0.76 | 280 |
| | 1.8 | 0.8 | 200.0 | 1.02 | 0.75 | 0.27 | 150 |
| After 15 | 2.4 | 0.0 | 200.0 | 1.01 | 1.01 | 0.00 | 120 |
| minutes | 0.0 | 2.9 | 203.2 | 1.00 | 0.00 | 1.00 | 270 |
| | 1.2 | 1.4 | 200.0 | 1.01 | 0.51 | 0.50 | 250 |
| | 0.6 | 2.2 | 200.0 | 1.02 | 0.26 | 0.76 | 320 |
| | 1.8 | 0.8 | 200.0 | 1.02 | 0.75 | 0.27 | 170 |

These results firstly show that the dissolution of calcium oxalate is, in general, around 5 times lower than the dissolution of calcium carbonate, but that MSA is around 2.3 times more active than phosphoric acid.

The activity of each acid is not proportional to the time: it is not three times greater after 15 minutes than after 5 minutes.

In all the cases, the addition of MSA to the phosphoric acid makes it possible to considerably improve the effectiveness of the phosphoric acid.

Moreover, the mixtures of acids are more active than MSA alone, especially with the H₃PO₄/MSA 1/3 mixtures, a solubilisation after 5 minutes of 280 mg/L is obtained, whereas theory shows that a solubilisation of 215 mg/L (110×0.25+250×0.75=215 mg/L) should be obtained. A synergy is also observed with the H₃PO₄/MSA 1/1 mixture (230 mg/L instead of 180 mg/L) and for the H₃PO₄/MSA 3/1 mixture (150 mg/L instead of 90 mg/L).

### EXAMPLE 3 (ACCORDING TO THE INVENTION)

### Dissolution of Calcium Oxalate with an MSA/HNO₃ Mixture

The tests from Example 2 are reproduced by replacing phosphoric acid with nitric acid, and the efficacies of the H₃PO₄/HNO₃ mixtures are compared relative to the MSA/HNO₃ mixtures. The total concentration of acids in demineralised water (% of active material) is 1.5% by weight (amount of water added to the mother solutions of mixtures of acids: 20 g).

The results are presented in Table 3 below:

TABLE 3

| | Quantity of acids (g) | | | % of acids after dilution | | | |
|---|---|---|---|---|---|---|---|
| | H₃PO₄ | MSA | HNO₃ | H₃PO₄ | MSA | HNO₃ | Ca²⁺ |
| | (g) | (g) | (g) | (%) | (%) | (% g) | (mg/L) |
| After 5 | 1.2 | — | 11.8 | 0.17 | 0.00 | 1.33 | 500 |
| minutes | — | 1.4 | 12.0 | 0.00 | 0.16 | 1.35 | 830 |
| | — | 7.2 | 7.4 | 0.00 | 0.76 | 0.76 | 570 |
| | — | — | 13.3 | 0.00 | 0.00 | 1.50 | 525 |
| | — | 14.3 | — | 0.00 | 1.50 | 0.00 | 375 |
| | 1.1 | — | — | 1.50 | 0.00 | 0.00 | 165 |
| After 15 | 1.2 | — | 11.8 | 0.17 | 0.00 | 1.33 | 500 |
| minutes | — | 1.4 | 12.0 | 0.00 | 0.16 | 1.35 | 830 |
| | — | 7.2 | 7.4 | 0.00 | 0.76 | 0.76 | 550 |
| | — | — | 13.3 | 0.00 | 0.00 | 1.50 | 525 |
| | — | 14.3 | — | 0.00 | 1.50 | 0.00 | 375 |
| | 1.1 | — | — | 1.50 | 0.00 | 0.00 | 165 |

Surprisingly, the amount of oxalate dissolved after 15 minutes is similar to the amount of oxalate dissolved after only 5 minutes.

Moreover, the mixtures of acids comprising MSA are still much more active than the H₃PO₄/HNO₃ mixtures, and in particular the mixtures comprising around 1.35% of HNO₃: 830 mg/L with MSA/HNO₃ and 500 mg/L with H₃PO₄/HNO₃.

These results show that, unlike the HNO₃/H₃PO₄ mixtures, the HNO₃/MSA mixtures exhibit a synergy: the test with the mixture of 0.16% MSA and 1.35% HNO₃ makes it possible to solubilise 830 mg/L of oxalate, against only 525 mg/L with nitric acid alone at a concentration of 1.5%.

It is thus observed that it is possible to use a smaller amount of nitric acid, when it is combined with MSA, to solubilise a larger amount of calcium oxalate.

1. A composition for descaling oxalates comprising a mixture of at least one alkanesulphonic acid with at least one other mineral acid.

2. The composition according to claim 1, wherein the mineral acid is chosen from hydrochloric acid, sulphuric acid, sulphamic acid, phosphoric acid, nitric acid, etc., and also mixtures of two or more of them in any proportions, preferably from phosphoric acid and nitric acid, and also mixtures thereof.

3. The composition according to claim 1, wherein the alkanesulphonic acid is chosen from the alkanesulphonic acids of formula R—SO₃H, where R represents a linear or branched saturated hydrocarbon-based chain comprising from 1 to 4 carbon atoms, preferably the alkanesulphonic acid is chosen from methanesulphonic acid, ethanesulphonic acid, n-propanesulphonic acid, iso-propanesulphonic acid, n-butanesulphonic acid, iso-butanesulphonic acid, sec-butanesulphonic acid, tert-butanesulphonic acid, and mixtures of two or more of them in any proportions, and more preferably the alkanesulphonic acid is methanesulphonic acid.

4. The composition according to claim 1, wherein the mineral acid is phosphoric acid and the alkanesulphonic acid is methanesulphonic acid.

5. The composition according to claim 4, comprising between 40% and 85% by weight of MSA and between 60% and 15% by weight of H₃PO₄, preferably around 75% by weight of MSA and around 25% by weight of H₃PO₄, or else around 50% by weight of MSA and around 50% by weight of H₃PO₄.

6. The composition according to claim 1, wherein the mineral acid is nitric acid and the alkanesulphonic acid is methanesulphonic acid.

7. The composition according to claim 6, comprising between 5% and 30% by weight of MSA and between 95% and 70% by weight of HNO₃, preferably around 10% by weight of MSA and around 90% by weight of HNO₃.

8. A formulation which comprises a composition according to claim 1, pure or diluted, in any aqueous, organic or aqueous-organic medium, preferably diluted in water at total acid concentrations between 0.2% and 50% by weight relative to the total weight of the formulation, preferably between 0.5% and 20%, more preferably between around 0.5% and 10% by weight relative to the total weight of the formulation.

9. The composition according to claim 1, and further comprising one or more additives selected from the group consisting of:
solvents, hydrotropic agents or solubilisers (for example alcohols, esters, ketones, amides, etc.);
biocides, disinfectants (bromoacetic acid, peracetic acid, salicylic acid, aqueous hydrogen peroxide solution, etc.);
rheological agents or texturing agents or thickeners or gelling agents (sugars, polysaccharides, alginates, silica, amorphous silica, gums, etc.);
flame retardants;
preservatives;
anionic, cationic, nonionic or amphoteric surfactants (such as ethoxylated alcohols and/or amines, alkylsulphonates and/or arylsulphonates), emulsifiers, detergents, soaps, etc.;
organic or mineral acids (for example sulphuric acid, phosphoric acid, nitric acid, sulphamic acid, acetic acid, citric acid, formic acid, lactic acid, glycolic acid, oxalic acid, etc.);
foaming agents and antifoaming agents;
antifreezes (for example ethylene glycol, propylene glycol, etc.);
colorants;
fragrances, odorous agents; and
corrosion-inhibiting additives.

10. A process for descaling, cleaning or dissolving any type of scale comprising at least one mineral or organic salt of oxalic acid, and in particular at least one alkaline-earth metal salt of oxalic acid, more particularly at least one calcium oxalate, in the form of residues, scales or depositions that are dry or still wet, said process comprising at least one step of bringing an effective amount of at least one composition of acids according to any one of the preceding claims, in the form of an aqueous, organic or aqueous-organic formulation, in the form of a solution, gel or foaming gel, into contact with said mineral or organic salt of oxalic acid to be removed, by contact, immersion, sprinkling, spraying, applying a thick or thin layer, said contacting step being optionally followed by one or more steps of rinsing and/or drying.

11. A method of descaling, cleaning or dissolving any type of scale comprising at least one mineral or organic salt of oxalic acid, and in particular at least one alkaline-earth metal salt of oxalic acid, more particularly at least one calcium oxalate, which comprises contacting the composition according to claim 1 with the scale.

12. The method of claim 11, wherein the scale is oxalate scale in the dairy and cheese industries, in industries where fermented beverages are prepared, especially brewing industries, in the fields of storage, transport and processing of early horticultural produce, vegetables (spinach for example), fruit (cocoa bean, tea, sugar beet, etc.), meat, fish, etc., but also for cleaning sanitary installations (sinks, basins, baths, showers, toilets) and also in the paper industry, and, as a general rule, any type of industry faced with the problem of the accumulation of oxalate scale.
